(19) United States
(12) Patent Application Publication
(10) Pub. No.: US 2013/0007821 A1
(43) Pub. Date: Jan. 3, 2013

(54) APPLICATION STRUCTURE FOR WEB-ENABLED COMPUTER ELECTRONICS DEVICES

(75) Inventor: Daniel Berkowitz, New York, NY (US)

(73) Assignee: NBCUniversal Media LLC, New York, NY (US)

(21) Appl. No.: 13/300,831

(22) Filed: Nov. 21, 2011

Related U.S. Application Data
(60) Provisional application No. 61/502,256, filed on Jun. 28, 2011.

(51) Int. Cl. H04N 7/173

(52) U.S. Cl. 725/105

(57) ABSTRACT

An electronic device, such as a web-enabled television has a device layer that defines certain hardware, firmware, and software constraints of the device, and a superapplication that interfaces with the device layer. The superapplication defines certain functionality that may be utilized by one or more applications that provide specifics of the user experience, such as colors and placement of text and graphics, functions that may be called by reference to the superapplication, and so forth. The structure may facilitate or eliminate the need for approval of applications once a superapplication is approved for use on the device. Multiple applications may be designed to function with the superapplication, such as to facilitate development and offering of applications, such as for different stations of television offerings.

### CROSS REFERENCE TO RELATED APPLICATIONS

This application is a Non-Provisional Application of U.S. Patent Provisional Application No. 61/502,256, entitled “Application Structure for Web-Enabled Computer Electronics Devices”, filed Jun. 28, 2011, which is herein incorporated by reference.

### BACKGROUND

The invention relates generally to web-enabled consumer electronics devices, such as televisions, and more particularly to application structures that will facilitate review and approval of web and similar applications while respecting constraints imposed on applications by device makers.

A large number of devices exist and are being developed for use with wide-area networks such as the Internet (all collectively referred to in the present disclosure as the “web”). For example, conventional televisions are being increasingly replaced with so-called web-enabled televisions. Conventional television sets were essentially receivers capable of capturing and decoding transmissions over the airwaves, and limited to unidirectional communication of broadcasts only. Increasingly, however, set-top boxes, computer interfaces, and outside services have greatly enhanced the capabilities of televisions, both as receivers and monitors, as well as for bi-directional data exchange in their own right.

Improvements in processing capabilities in televisions will soon make much more functionality feasible with and without resort to external devices, such as connected set-top boxes and computers. In all of these scenarios, however, web-type applications may be executed using the television as an interface. Particularly of interest are fully capable television sets that allow such applications to be run, providing essentially stand-alone capabilities, at least for certain functionality defined by the applications loaded and executed.

Ultimately the interest, utility and enjoyment of these devices will depend upon the particular applications that are developed and available. The veritable explosion of applications available for smartphones, tablet computers, and other handheld devices provides a poignant example of the type of escalation that can be expected for televisions. Such applications may range from those drawing from online media, as well as applications that allow for access to sites, on-demand content, social networking, messaging, games, streaming content (music, video, etc.), and so forth, both complementing scheduled television programming and fully separate from such programming (sometimes referred to as “always-on” content).

As with application development for smartphones and similar devices, however, it might also be anticipated that the rapidity of development and availability of applications for web-enabled televisions and similar devices will be hindered by approval processes, particularly any such processes imposed by the consumer electronics industry and particular manufacturers. These processes are highly important insomuch as they ensure that applications released and loaded (free or for a fee) will function properly on the device without aggravating and distracting run-time problems that would otherwise alienate the desired audiences. However, long delays in approval may, conversely, severely limit the attractiveness of any particular product or line of products from a manufacturer, allowing others to fulfill audience desires first. Manageable application approval delays and processes will also tend to attract more developers who stand to profit from the applications, enhancing the opportunities for the developers, the device makers, and content providers.

There is a need in the field for improved techniques for structuring and formulating applications for web-enabled televisions that will fulfill these needs.

### BRIEF DESCRIPTION

The present invention provides a novel technique for content delivery via applications available and/or stored on a consumer electronic device such as a web-enabled television. The applications are structures to facilitate their development, implementation, testing and approval by device makers and anyone else involved in the approval process.

In accordance with certain aspects of the technique, an interactive consumer electronic system comprises a superapplication layer stored on a non-transitory computer readable medium on a media device. The superapplication layer is device platform-specific to operate with the media device in accordance with a device platform for playing digital content and for receiving and processing inputs from a user of the media device in response to the digital content and for receiving and processing inputs from an external server. The superapplication layer implements a communications protocol and acts on messages received from the external server in accordance with the protocol. The superapplication layer is also configured to operate with an application stored on the media device that is device platform-agnostic and is authorized to reference and invoke functionalities of the superapplication layer through a secure protocol for adaptation of content for playing on the media device.

The invention also provides an interactive consumer electronic system that comprises a media device configured to play digital content, and an input device associated with the media device and configured to permit user inputs in response to the digital content. A superapplication layer is stored on a non-transitory computer readable medium on the media device, and is device platform-specific to operate with the media device in accordance with a device platform for playing digital content and for receiving and processing inputs from a user of the media device in response to the digital content and for receiving and processing inputs from an external server. The superapplication layer implements a communications protocol and acts on messages received from the external server in accordance with the protocol. At least one device platform-agnostic application is stored on the media device and is authorized to reference and invoke functionalities of the superapplication layer through a secure protocol for adaptation of content for playing on the media device.

Still further, the invention offers a computer implemented method executable based upon code stored on at least one non-transitory computer readable memory of a media device. The method comprises, via a device platform-specific superapplication layer stored on the non-transitory computer readable medium on a media device, interacting with the media device in accordance with a device platform for playing digital content and for receiving and processing inputs from a user of the media device in response to the digital content and for receiving and processing inputs from an external server. The superapplication layer implements a communications protocol and acts on messages received from the external server in accordance with the protocol, the superapplication layer is also configured to operate with an application stored on the media device that is device platform-agnostic and is authorized to reference and invoke functionalities of the superapplication layer through a secure protocol for adaptation of content for playing on the media device.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary content delivery system employing an application structure in accordance with the present techniques;

FIG. 2 is a diagrammatical representation of an exemplary application structure utilizing a “superapplication” and one or more “templates” that may be defined to provide specific information, content, functionality, and so forth;

FIG. 3 is a flow chart illustrating presently contemplated processes for establishing and approving applications based upon the improved structuring outlined in FIG. 2; and

FIG. 4 is a flow chart illustrating exemplary steps in the loading and execution of a superapplication and an application as presently contemplated.

### DETAILED DESCRIPTION

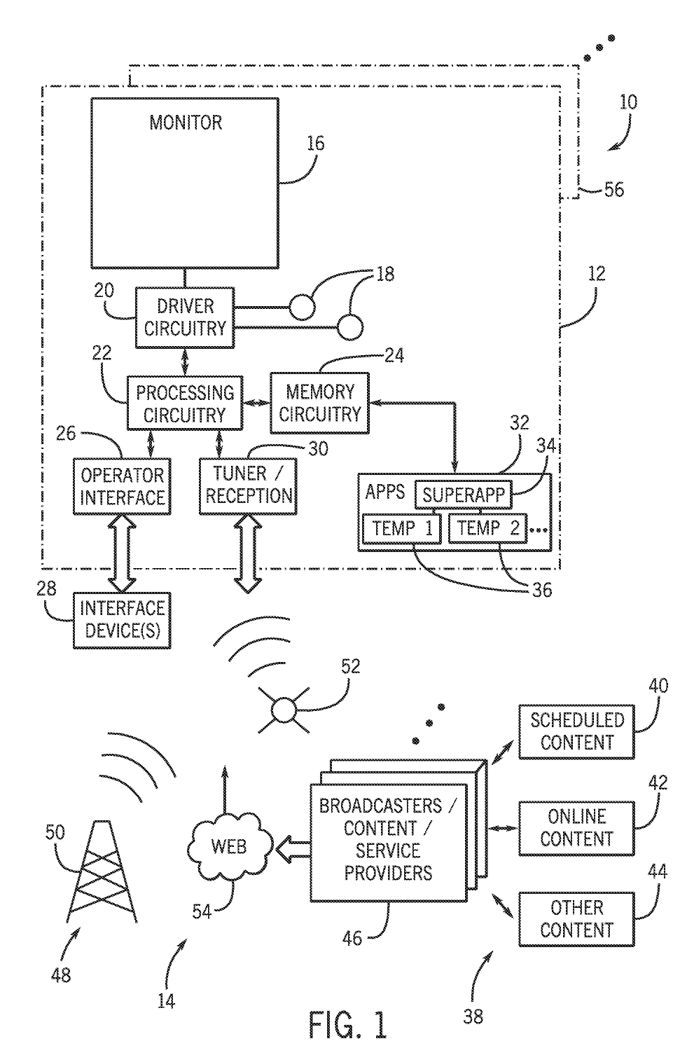

Turning to the drawings, FIG. 1 represents an exemplary content delivery system 10 adapted to deliver content to and carry out functionality on a consumer electronic device 12, such as a web-enabled television. The content is provided by a content delivery site, designated by reference numeral 14, which will provide for both unidirectional data transfer (e.g., via scheduled broadcast) and bi-directional data transfer (e.g., for online, on-demand, streaming and other content, as well as interactive web-based data).

The device 12, again illustrated here as a television, includes a monitor 16 for watching video content, and speakers 18 for audio output. Driver circuitry 20 provide signals to the monitor and speakers, and these elements may be of generally conventional construction and operation. Processing circuitry 22 allows for control of the monitor and speakers, and more generally, coordinates operation of the device. That is, the processing circuitry may carry out operations of conventional television receivers, including encoding and decoding data, tuning control, channel selection, volume and picture control, and so forth. In addition, for the web-enabled device shown, the processing circuitry 22 is adapted to execute code in the form of one or more applications. For all of these functions, memory circuitry 24 is provided, where operational parameters, such as settings, view preferences, applications, and so forth may be stored. It should be noted, however, that in practice, various processing circuits and memory devices may be employed, and the device may include or make use of multiple specialized processors and/or memory devices, both internal to the device and external.

The processing circuitry 22 will interact with operator interface circuitry 26 that can output signals and receive command signals from one or more interface devices 28. Such interface devices may include on-set controls (e.g., selector buttons), but more importantly, conventional remote controls and specialized input devices, such as keyboards, user input selectors, game controls, and so forth. These may be conventional in nature, such as wired or wireless keyboards, or adapted for particular applications, such as for navigating content, requesting content, interfacing with specific applications, and so forth. It should be noted that the interface devices may include the monitor itself, such as in the case of certain portable viewing devices with touch-screen capabilities. Similarly, the processing circuitry 22 communicates with tuner/reception circuitry 30 through which the processing circuitry receives broadcasts, digital data, web-based content, and so forth. Thus certain functionality of this circuitry may be entirely conventional (e.g., receipt of land or satellite-emitted broadcasts), while other functions will be adapted for bi-directional interaction with content and service providers.

Processing circuitry 22 is adapted to execute one or more applications 32 that may be available to and/or stored on the device 12. In many cases, all of the applications may be stored on the device itself, and executed by the processing circuitry based upon user commands or triggered by other content-related or system events. However, in some cases the applications may be stored off of the device, such as in a service-provider repository (e.g., in the “cloud”). The applications may thus be downloaded free or for a fee, or may be executed remotely or partially remotely upon command from the user of the device or triggered by other content-related or system events. In presently contemplated embodiments, the particular location and manner of execution of these applications is essentially transparent to the user, who merely benefits from the informational and/or entertainment value of the applications by viewing and/or listening to content and interacting with the applications in accordance with their defined functionalities.

As discussed in the present disclosure, the application approach and structure proposed has a number of potential benefits as compared to current technologies. For example, in certain embodiments, the relationship between the application developers, the content providers and the parties approving the applications for use on the devices (typically the device makers) may be greatly facilitated. The device makers will generally provide guidelines or constraints for all applications allowed to function on the device, in what may be termed a “device layer” or native platform. One or more “superapplications” for a superapplication layer and may interact with this device layer to define the basic operation of the application. A supplemental application may then be layered on the superapplication layer to provide additional information needed for the user experience, such as graphics, layout, and user interface. As described below, the superapplication layer is device platform-specific to operate with the device layer in accordance with a device platform for playing digital content and for receiving and processing inputs from a user of the media device in response to the digital content and for receiving and processing inputs from an external server. Moreover, the superapplication layer implements a communications protocol and acts on messages received from the external server in accordance with the protocol. The superapplication layer is also configured to operate with an application stored on the media device that is device platform-agnostic and is authorized to reference and invoke functionalities of the superapplication layer through a secure protocol for adaptation of content for playing on the media device.

This structure may result in many advantages. For example, the superapplication may be subject to approval by the device maker (with or without an application or application “template”). Subsequent applications may be built around a template that is specifically designed for use with the superapplication, and that may draw on code, functions, settings, and so forth of the superapplication without changing the fundamental operation of the superapplication. The superapplication may thus serve as an interface between the more specific application and the device layer. Subsequent approval of specific applications, then, may be abbreviated or not required at all.

Moreover, the structure allows device makers (e.g., web-enabled television set makers) to accommodate groups of content/service providers who can choose to design and differentiate their own products without being bound by constraints of a single platform. For example, a content/service provider may utilize a similar look and feel for its applications, use the same or similar graphics, and provide a similar user experience, all still following the dictates of the device layer. Application developers and content providers may also offer similar applications for different platforms, and to the extent possible there may be little or no difference between the applications, with the superapplication effectively adapting the application details to the specific device layer constraints.

Still further, it should be appreciated that the superapplication layer, and the one or more superapplications that define it, is not simply a browser-type application or a flash or HTML technique or similar to a java virtual machine or a data link library. For example, it is contemplated that the superapplication layer will be device platform-specific, providing, by way of example, functionalities for presentation of content that are adapted for specific devices, families of devices, manufactures specifications, and so forth. The ability of the superapplication layer to interact with external servers for content and instructions alleviates the need for the applications that co-act with the superapplication layer to be, themselves, platform-specific, and so these may be generally agnostic, and may even operate with different superapplication layers adapted for different device platforms, as mentioned above. Still further, the applications are authorized to draw upon the functionalities of the superapplications of the superapplication layer in a secure manner, rendering the superapplication layer useful specifically for the intended interactions.

At least one (and perhaps most or all) of the applications comprises one or more superapplications 34 in conjunction with one or more template applications 36. As discussed below, the superapplication is designed in accordance with the constraints offered by the processing circuitry, available memory, power limitations, video and/or audio limitations, and so forth of the device. The superapplication, then, defines technical and performance parameter constraints, including functionalities available from the template applications. In practice, the superapplication and any particular template application may be considered (and perceived to the user) as a single application. In practice, acquisition (e.g., downloading) of a desired application may involve downloading of a superapplication/template application pair, or simple downloading a further template application in the event a superapplication is already downloaded (or otherwise available). The present implementations allow for both possibilities. In addition, the applications may be structured to employ more than one template applications in conjunction with one superapplication, the entire set being operational and perceived to the user as a single application.

The device will receive and/or request and receive primary content 38 in various forms. For example, this may include scheduled content 40, such as conventional television programming. In addition, online content 42 may be provided, such as web pages, audio content, video content, streaming content, and so forth, which will typically be delivered via the Internet. Other content 44 may also be provided, such as on-demand content, time shifted content, content owned or controlled by the user but stored by a provider, software downloads, applications, and so forth. The content will typically be provided by one or more providers 46, such as broadcasters, content providers, service providers (e.g., Internet service providers) and so forth. These may make use of known transmission channels 48, such as conventional airwave distribution systems 48, satellite (and/or cable) systems 52, and web-based distribution systems 54. It should be noted, however, that the present techniques are not limited to any particular delivery mechanism, and these may include, for example, local area networks, set-top and cable boxes, and so forth. Finally, it should be noted that the application structure contemplated here may be implemented in a range of devices other than fully integrated web-enabled televisions, as indicated generally by reference numeral 56. These might include, for example, so-called set-top boxes, cable and satellite boxes, game stations, and so forth.

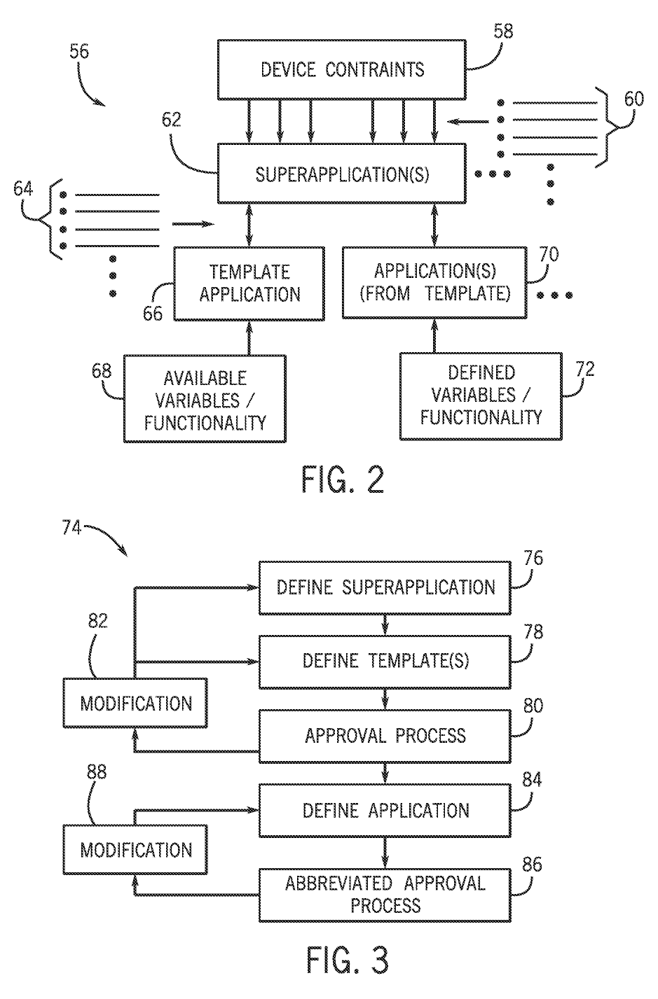

FIG. 2 illustrates an exemplary application structure for a superapplication and templates or applications defined based on the templates. The structure begins with the device layer 58, or native platform that will be defined by the electronic device (e.g., web-enabled television). For applications developers, the device manufacturer, industry standards, or both, will define a series of limitations and functionalities that all applications will need to respect in order to gain approval for use on the device. These may comprise, for example, memory usage, instruction sets, specialized processor usage, the type of Internet connection, parsing mechanism for messages to the application, functionality for types of operations, and so forth, as represented generally by reference numeral 60. It should be noted that the device layer may also provide code and functionality that may serve as a resource to superapplications (and applications), and that generally define the way in which the superapplications (and applications) may interact with the device layer and control the device. These constraints will be implemented in and respected by the superapplication 62, which will typically consist of code written in any suitable language, and including predefined inputs, outputs, functionality, and so forth depending upon the nature of the applications involved (e.g., news, content streaming, games, graphics, music playback, video playback, etc.). By way of example, a content provider may wish to offer several different applications, such as one that performs polling, another that performs commerce, yet another that permits requests for samples, still another for sports scores, a further that provides recaps of previous episodes in a series, biographies of athletes, still another that provides social television enabling viewers to view comments by others and to make comments about programming, another for news and information, and so forth. The superapplication 62 will predefine certain shared variables and functionality that such applications will utilize.

As noted above, the superapplication may be platform-specific. That is, it may be designed to interface with a specific platform layer defined by a specific manufacturer of the device on which it is designed to work. The superapplication, then frees the application from most or all of such device-specific constraints, so long as the application defined code that properly interacts with the superapplication. Moreover, the superapplication may be “versioned” along with the device or any application layer code operational on the device, where required for proper operation, and updated versions of the superapplication may, from time to time, be desired to adapt to changes in the device layer. Similarly, the applications may be “versioned” to accommodate different superapplications.

The superapplication 62, however, will generally be incomplete insomuch as certain content and/or functionality is not fully defined. Such content and/or functionality may include, for example actual sports scores for a sports template or application (e.g., with a scrolling score bar), current market values of stocks in a business or ticker stock template or application. However, the superapplication 62 will define one or more variables that should be provided or respected in any code that completes the superapplication to provide the desired content and/or functionality in the final product. Such variables may include, for example the manner in which content, text and graphics are presented, positioning of content elements, messages that may be expected from a server, background color and graphics, functioning of buttons, and so forth, as indicated generally by reference numeral 64. The structure 56 then includes one or more template applications 66 that comprise code that may be completed for providing the content and/or functionality desired of the final product. However, the template 66 itself may form a shell or outline in which available variables and/or functionality may be defined, as indicated by reference numeral 68. The template itself may be more or less detailed, and in certain cases, a high degree of completion may be offered, such that little additional definition is required to convert the template to a full application 70 that provides, in cooperation with the superapplication 58, the desired content and/or functionality. It should be noted, however, that various programming techniques may be used in defining the template application and in its conversion/completion to an application, such as calls or tags to graphics, content, subroutines, code written in various languages (e.g., XML, CHP, java), and so forth.

One or more applications 70 are thus formed by supplying defined variables and/or functionality as indicated by reference numeral 72. These variables and/or functionality will correspond to those indicated as available in the template, as indicated by reference numeral 68. It is contemplated that a substantial number of final application products may be thus produced by reuse of the template application 66 in conjunction with the superapplication. These application products will, then, inherently and necessarily respect the limitations and functionalities 60 defined for all applications by the device constraints 58.

For example, content or service provider with multiple available channels of programming, may desire to maintain a desired “back end functionality” that would be defined by one or more superapplications. The fundamental application logic may thus be decoupled from the display logic, which would be provided by one or more applications that cooperate with the superapplication. Thus, multiple “stations” on television may share a superapplication to be capable of providing news, stock quotes, retrieve data from news feeds, and so forth. Each station may call upon the same superapplication, but with different features (e.g., a stock ticker on a financial station, sports scores on a sports station) and different looks crafted for each station. The calls to servers, however, may be different, and structured differently, with these typically being defined by the superapplication.

It is contemplated that the application structure employing such superapplications and template applications may substantially enhance the process of evaluation and approval of applications for consumer electronics devices, and particularly for web-based televisions. FIG. 3 summarized certain steps in this process. The process 74 begins with definition of the superapplication, as indicated by reference numeral 76. Again, this definition will typically consist of development of code that will define the overall structure of the application, respect the limitations and functionalities of the device, and provide definition of the variables available for templates. At step 78, then, the template application is similarly defined, providing and respecting the variables definitions of the superapplication.

At step 80, then, the combined superapplication and template application may be considered in the application approval process. It should be noted, however, that where desired, this approval may be based upon an actual application completed based on the template, and having the final content and/or functionality. This may allow the approving party to fully consider the operation of the application on the device, and any interactions of the application with other software, content and devices. As needed, modifications may be required to the superapplication and/or the template application (or subapplication) as indicated by reference numeral 82. The process ultimately leads, then, to approval of the combined application.

Subsequently, then, owing to the modular and subordinated structure of the superapplication and template (or application), the approval process may be substantially facilitated and abbreviated. For example, based upon the original superapplication/template (or application) combination, a particular (or further) application may be defined, as indicated by reference numeral 84. This application will necessarily respect all constraints imposed by the superapplication, and thereby those of the device. It is contemplated that the approval process for such further applications may be abbreviated, as indicated by reference numeral 86. Indeed, it is contemplated that in certain scenarios, if properly implemented, the application may require no separate or supplemental approval at all. Of course, this process may require further modification, likely primarily or only of the application, as indicated by reference numeral 88. However, based upon the previously approved combination, the subsequent approval process, which considers an application product assured of respecting the constraints of the device, should be greatly facilitated.

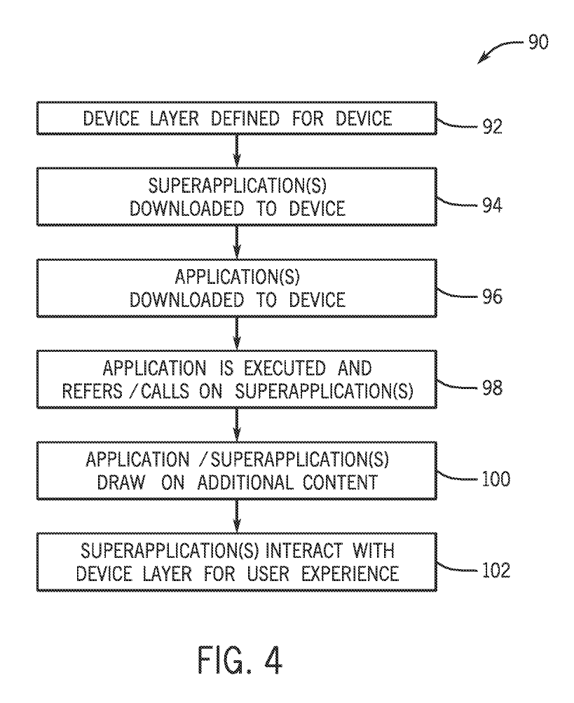

An exemplary use case for the superapplication and application structure is illustrated generally in FIG. 4. The process, designated generally by reference numeral 90, begins at step 92 with the definition of the device layer for the device. As discussed above, this will generally be done by the device maker, who will define and install the device layer on the device. This layer may be defined partially as a function of the hardware and firmware of the device, but will typically include code for graphics capabilities, display size, memory utilization, type of Internet connection (and available band width), and so forth. At step 94, then, one or more superapplications may be downloaded (or otherwise provided) on the device. Here again, the superapplication will typically be specifically designed to interact with the device layer, and will respect those constraints, functionalities, hardware, firmware and software specifics of the device, and may be versioned for particular models and versions of the device. The superapplication may effectively act as an intermediary between applications and the device layer, and may function as a “library” of available functions for the applications. Accordingly, the superapplication may define such variables as Template types, back end server connections (the servers with which it may exchange data) protocols for data exchange, functions that may be called, variables that are passed into those functions, whether persistent storage is needed and if so, how it is handled, and so forth. At step 96, then, one or more applications are downloaded (or otherwise provided) on the device. The download of both the superapplication and/or application may be done by user or service provider selection, such as from a menu or library of available superapplications and applications, although in some cases one or more of these may already be present on the device. Here again, one or more of the superapplications and/or applications may be free or available for a fee, available with a subscription service, or according to any other desired business mode. In some contexts, one or more superapplications and one or more applications may be pre-installed for preferred providers, and further installation and/or removal of these may be limited.

After installation, then, the application or applications may be executed as indicated at step 98. The application will typically be executed on the device processor or processors. In the execution, the application will refer to or call upon one or more superapplications for interaction with the device layer. For example, for a news application, such interaction may consist of providing stock quotes in a ticker, providing data in a “flipper” (where data is displayed then periodically replaced), querying stock prices for display on a screen, and so forth (to be used by templates available in the superapplication). Such factors as the position, color, display parameters, and so forth will typically be determined by the application, while the “function call” used when functionality is made will typically be defined by the superapplication. It should be noted that, owing to the modular structure of the programs, one or more superapplications may be called upon by a particular application, and superapplications may refer to one another where possible, such as for providing a stock ticker, sports scores, news feeds, and so forth. It is also contemplated that one or more superapplications may communicate via special software interfaces so that an application executing within a superapplication may have access to resources and/or templates from one or more other superapplications.

In many scenarios, the application and/or the superapplication may draw upon additional content, such as from the Internet, as indicated at step 100. This process may involve accessing data from specific sites or servers, and will typically be done based upon the desired function of the application (e.g., to provide real-time sports scores, market ticker updates, etc.) and/or selections made by the user. Ultimately, as indicated at step 102, the superapplication interacts with the device layer to provide the desired user experience, such as the display of video, playback of audio, provision of on-screen data, graphics, product/service offerings, interactive gaming, and so forth. This entire process may be more-or-less interactive, depending upon the device capabilities, the nature of the applications and superapplications, and the user desires.

It should be noted that in certain scenarios, it may be desired to limit access to the functionality of superapplications to certain applications. That is, the applications that operate with a superapplication may be limited, such that only those applications that should be able to use the superapplication will be able to do so. A number of schemes may be envisioned for such security, such as encrypting. This may also reduce or eliminate the risk of reverse-engineering of the superapplication, tempering with the superapplications, and so forth.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An interactive consumer electronic system comprising:
a superapplication layer stored on a non-transitory computer readable medium on a media device, the superapplication layer being device platform-specific to operate with the media device in accordance with a device platform for playing digital content and for receiving and processing inputs from a user of the media device in response to the digital content and for receiving and processing inputs from an external server, the superapplication layer implementing a communications protocol and acting on messages received from the external server in accordance with the protocol, the superapplication layer also configured to operate with an application stored on the media device that is device platform-agnostic and is authorized to reference and invoke functionalities of the superapplication layer through a secure protocol for adaptation of content for playing on the media device.

2. The system of claim 1, wherein the superapplication layer comprises a plurality of functions configured to be utilized by the application for playing the content on the media device.

3. The system of claim 1, wherein the superapplication layer is configured to interface with a plurality of applications for adaptation of the parameters of the content.

4. The system of claim 1, wherein the media device comprises processing circuitry configured to execute the superapplication layer to interface with the application.

5. The system of claim 1, wherein the superapplication layer and the application are configured to play the content with primary content played on the media device.

6. The system of claim 1, wherein the content comprises text displayed over primary content on the media device.

7. The system of claim 1, wherein the application comprises an interactive application configured to receive and act upon input from a user of the media device.

8. The system of claim 1, wherein the superapplication layer is configured for approval by a manufacturer of the media device, and the application is not subject to approval by the manufacturer.

9. The system of claim 1, comprising a plurality of superapplications, wherein each superapplication comprises functionalities that are referenced and invoked by the application for adaptation of content for playing on the media device.

10. An interactive consumer electronic system comprising:
a media device configured to play digital content;
an input device associated with the media device and configured to permit user inputs in response to the digital content;
a superapplication layer stored on a non-transitory computer readable medium on the media device, the superapplication layer being device platform-specific to operate with the media device in accordance with a device platform for playing digital content and for receiving and processing inputs from a user of the media device in response to the digital content and for receiving and processing inputs from an external server, the superapplication layer implementing a communications protocol and acting on messages received from the external server in accordance with the protocol ; and
at least one device platform-agnostic application stored on the media device and authorized to reference and invoke functionalities of the superapplication layer through a secure protocol for adaptation of content for playing on the media device.

11. The system of claim 10, wherein the media device comprises an internet-ready television.

12. The system of claim 10, wherein the content processed by the application is played over the digital content.

13. The system of claim 10, comprising a plurality of superapplications, wherein each superapplication comprises functionalities that are referenced and invoked by the application for adaptation of content for playing on the media device.

14. The system of claim 10, wherein the superapplication layer is configured to interface with a plurality of applications for adaptation of the parameters of the content.

15. The system of claim 10, wherein the content comprises text displayed over primary content on the media device.

16. A computer implemented method executable based upon code stored on at least one non-transitory computer readable memory of a media device, the method comprising:
via a device platform-specific superapplication layer stored on the non-transitory computer readable medium on a media device, interacting with the media device in accordance with a device platform for playing digital content and for receiving and processing inputs from a user of the media device in response to the digital content and for receiving and processing inputs from an external server, the superapplication layer implementing a communications protocol and acting on messages received from the external server in accordance with the protocol, the superapplication layer also configured to operate with an application stored on the media device that is device platform-agnostic and is authorized to reference and invoke functionalities of the superapplication layer through a secure protocol for adaptation of content for playing on the media device.

17. The method of claim 16, further comprising processing content received via the further application to be played over the digital content.

18. The method of claim 17, wherein the processed content comprises text displayed over primary content on the media device.

19. The method of claim 17, wherein the superapplication layer is configured to adapt a layout of the processed content in accordance with the device platform.

20. The method of claim 16, wherein the superapplication layer comprises a plurality of superapplications each having functionalities that are referenced and invoked by the application.
